(19) United States
(12) Patent Application Publication
(10) Pub. No.: US 2021/0136804 A1
(43) Pub. Date: May 6, 2021

(54) METHOD AND DEVICE FOR TRANSMITTING SIGNAL

(71) Applicant: Samsung Electronics Co., Ltd., Suwon-si, Gyeonggi-do (KR)

(72) Inventors: Chen QIAN, Beijing (CN); Bin YU, Beijing (CN); Qi XIONG, Beijing (CN)

(21) Appl. No.: 17/044,839

(22) PCT Filed: Apr. 2, 2019
(86) PCT No.: PCT/KR2019/003868

§ 371 Date: Oct. 1, 2020

(30) Foreign Application Priority Data
Apr. 4, 2018 (CN) 201810299684.8

(51) Int. Cl. H04W 72/12; H04L 1/18; H04W 52/36; H04B 1/713

(52) U.S. Cl. CPC H04W 72/1289; H04W 72/1257; H04B 1/713; H04W 52/362; H04L 1/1819

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services.

The present application discloses a method and device for transmitting a signal. the method comprises: detecting a downlink control channel by a user equipment (UE) using a compact downlink control information (DCI) format; acquiring configuration information by the UE in a preconfigured manner when the UE correctly detected the downlink control channel using the compact DCI format; performing an uplink transmission by the UE based on the configuration information. It is easy for the UE to acquire the scheduled uplink transmission and/or the downlink transmission, and the corresponding feedback information using the compact DCI format to complete the transmission of the corresponding signal.

### CROSS-REFERENCE TO RELATED APPLICATIONS

This application is a 371 National Stage of International Application No. PCT/KR2019/003868, filed Apr. 2, 2019, which claims priority to Chinese Patent Application No. 201810299684.8, filed on Apr. 4, 2018, the disclosures of which are herein incorporated by reference in their entirety.

### BACKGROUND

### 1. Field

The present application relates to wireless communication system technologies, and in particular, to a method and a device for transmitting signals.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

A transmission performed in a wireless communication system includes a transmission from a base station (gNB) to a user equipment (UE) (referred to as a downlink transmission), of which a corresponding time slot is called a downlink time slot, and a transmission from a user equipment (UE) to a base station (referred to as an uplink transmission), of which a corresponding time slot is called an uplink time slot.

In the downlink communication of the wireless communication system, a reliability of receiving downlink data is ensured by a Hybrid Automatic Repeat reQuest (HARQ) technique. Downlink data is transmitted from the base station to the UE through a Physical Downlink Shared Channel (PDSCH), and the UE informs the base station, by transmitting a Hybrid Automatic Repeat request-Acknowledgement (HARQ-ACK) feedback information, whether the UE correctly received the PDSCH. The HARQ-ACK information is transmitted from the UE to the base station through a Physical Uplink Control Channel (PUCCH).

For each transmission block (TB) in the received PDSCH, or the received Physical Downlink Control Channel (PDCCH) indicating the release of the Semi-Persistent Scheduling (SPS) (hereinafter, the above two are collectively referred to as a downlink HARQ transmission), the UE is required to feed ACK (correct reception) bits or NACK (error reception or loss) bits (which are hereinafter collectively referred to as HARQ-ACK bits) back to the base station through a corresponding uplink subframe. If the gNB received the NACK bits, the transmission block corresponding to the NACK or the PDCCH indicating the release of the SPS would be retransmitted.

In a new radio (NR) communication system, the performance of a random access directly affects the user's experience before establishing a radio resource control, such as during the random access procedure. In a conventional wireless communication system, such as LTE and LTE-Advanced, the random access procedure is applied to a plurality of scenarios such as an establishment of an initial link, a cell handover, a re-establishment of an uplink, and a RRC connection re-establishment, etc., and divided into a contention-based random access and a contention-free random access according to whether the user monopolizes a preamble sequence resource. In the contention-based random access, since each user selects a preamble sequence from the same preamble sequence resources during the process of attempting to establish the uplink, and multiple users may select the same preamble sequence to send to the base station, conflict resolution mechanism is an important research direction in the random access, and it is a key indicator affecting the performance of the random access how to reduce a probability of the conflict and how to quickly resolve the conflict that has already occurred.

The contention-based random access procedure in LTE-A is divided into four steps, as illustrated in FIG. 2. In the first step, the user randomly selects a preamble sequence from a preamble sequence resource pool and sends the selected sequence to the base station. The base station performs a correlation detection on the received signal to identify the preamble sequence sent by the user. In the second step, the base station sends random access responses (RARs) to the user, including a random access preamble sequence identifier, a timing advance instruction determined based on the delay estimate between the user and the base station, a Cell-Radio Network Temporary Identifier (C-RNTI), and a time-frequency resource allocated for the next uplink transmission of the user. In the third step, the user sends a third message (Msg3) to the base station according to information in the RAR. The Msg3 includes information such as a user terminal identifier and a RRC link request, etc., where the user terminal identifier is an unique to the user and is used to resolve the conflict. In the fourth step, the base station sends a conflict resolution identifier to the user, including a user terminal identifier of the user who wins in the conflict resolution. After detecting his or her identification, the user upgrades a temporary C-RNTI to a C-RNTI, sends an ACK signal to the base station to complete the random access procedure and waits for the scheduling of the base station. Otherwise, the user will start a new random access procedure after a period of time delay.

For the contention-free random access procedure, the preamble sequence can be assigned to the user since the base station knows the user identification. Therefore, when transmitting the preamble sequence, the user does not need to randomly select the sequence, but uses the assigned preamble sequence. After detecting the assigned preamble sequence, the base station sends a corresponding random access response, including information such as a timing advance and an uplink resource allocation, etc. After receiving the random access response, the user considers that uplink synchronization has been completed and waits for further scheduling of the base station. Therefore, the contention-free random access procedure only includes two steps: S1 is a step of sending a preamble sequence; and S2 is a step of sending a random access response.

The random access procedure in LTE is applicable to the following scenarios:

1. Initial access under RRC IDLE;

2. Re-establishing the RRC connection;

3. Cell handover;

4. In the RRC connection state, the downlink data arrives and requests a random access procedure (when the uplink is in a non-synchronous manner);

5. In the RRC connection state, the uplink data arrives and requests a random access procedure (when the uplink is in the non-synchronous manner, or a scheduling request is not allocated with a resource from the PUCCH resource);

6. Positioning.

In the LTE, the above six scenarios use the same random access procedure.

### SUMMARY

When the UE transmits the HARQ-ACK feedback information through the PUCCH, the UE needs to know the PUCCH resource for transmitting the HARQ-ACK. However, when the UE is before RRC being connected, when the system uses the compact PDCCH format to schedule uplink resources or downlink resources, there is no good solution for setting the redundancy version and setting the transmission power control, and the like, and it needs to be solved.

An object of the present application is to overcome a deficiency of the prior art and provide a method and device for transmitting a signal when scheduling an uplink or downlink transmission using a compact downlink control signaling.

To achieve the above object, the present application provides a method for transmitting a signal, the method includes the following steps:

detecting a downlink control channel by a UE using a compact DCI format;

acquiring configuration information by the UE in a preconfigured manner when the UE correctly detected the downlink control channel using the compact DCI format;

performing an uplink transmission by the UE based on the configuration information.

Preferably, the configuration information includes at least one of the following:

a redundancy version configuration used by a scheduled uplink resource;

a transmission power control configuration used by the scheduled uplink resource;

a frequency hopping flag configuration used by the scheduled uplink resource;

a transmission power control configuration used by a HARQ feedback resource corresponding to a scheduled downlink resource;

a resource indication configuration used by the HARQ feedback resource corresponding to the scheduled downlink resource;

a time interval configuration used by the HARQ feedback resource corresponding to the scheduled downlink resource.

Preferably, when the configuration information includes the redundancy version configuration used by the scheduled uplink resource, the acquiring the configuration information by the UE in the preconfigured manner, comprising at least one of:

the UE using the same redundancy version as the redundancy version configured by an uplink license carried in a random access response as the redundancy version configuration used by the scheduled uplink resource;

the UE using a preset redundancy version as the redundancy version configuration used by the scheduled uplink resource;

the UE determining the redundancy version configuration used by the scheduled uplink resource in an order of an uplink transmission and an order of the preset redundancy version

Preferably, when the configuration information includes the transmission power control configuration used by the scheduled uplink resource, the acquiring the configuration information by the UE in the preconfigured manner, comprising at least one of:

using, by the UE, the same configuration as the transmission power control configured by an uplink license carried in a random access response as the transmission power control configuration used by the scheduled uplink resource;

using, by the UE, a preset value of the transmission power control as the transmission power control configuration used by the scheduled uplink resource;

determining, by the UE, the transmission power control configuration used by the scheduled uplink resource based on the number of retransmissions sent by the uplink and a transmission power control step size preset by a system.

Preferably, when the configuration information includes the frequency hopping flag configuration used by the scheduled uplink resource, the acquiring the configuration information by the UE in the preconfigured manner, comprising at least one of:

using, by the UE, the same configuration as the frequency hopping flag configured by an uplink license carried in a random access response as the frequency hopping flag configuration used by the scheduled uplink resource;

using, by the UE, a preset frequency hopping flag configuration as the frequency hopping flag configuration used by the scheduled uplink resource;

determining, by the UE, the frequency hopping flag configuration used by the scheduled uplink resource based on a preset rule, wherein the preset rule comprises: if the number of the scheduled uplink transmission exceeds a preset number of retransmissions, the UE determines that the frequency hopping flag configuration used by the scheduled uplink resource is enabling the frequency hopping, otherwise the UE determines that the frequency hopping flag configuration used by the scheduled uplink resource is disenabling the frequency hopping.

Preferably, when the configuration information includes the transmission power control configuration used by the HARQ feedback resource corresponding to the scheduled downlink resource, the acquiring the configuration information by the UE in a preconfigured manner, comprising at least one of:

using, by the UE, the same configuration as the transmission power control configured by an uplink license carried in a random access response as the transmission power control configuration used by the HARQ feedback resource corresponding to the scheduled downlink resource;

using, by the UE, the same configuration as the transmission power control configured in the latest scheduled uplink transmission as the transmission power control configuration used by the HARQ feedback resource corresponding to the scheduled downlink resource;

using, by the UE, a preset value of the transmission power control as the transmission power control configuration used by the HARQ feedback resource corresponding to the scheduled downlink resource;

determining, by the UE based on the number of retransmissions sent by the uplink and a transmission power control step size preset by a system, the transmission power control configuration used by the HARQ feedback resource corresponding to the scheduled downlink resource.

Preferably, when the configuration information includes the resource indication configuration used by the HARQ feedback resource corresponding to the scheduled downlink resource, the acquiring the configuration information by the UE in a preconfigured manner, comprising at least one of:

determining, by the UE based on a resource index of receiving the correct PDCCH, the PUCCH resource configuration used by the HARQ feedback resource corresponding to the scheduled downlink resource from a PUCCH resource configuration set configured or pre-configured in the system information;

determining, by the UE, the PUCCH resource configuration used by the HARQ feedback resource corresponding to the scheduled downlink resource based on the pre-configured PUCCH resource configuration.

Preferably, when the configuration information includes the time interval configuration used by the HARQ feedback resource corresponding to the scheduled downlink resource, the acquiring the configuration information by the UE in a preconfigured manner, comprising at least one of:

using, by the UE, a preset time interval as the time interval configuration used by the HARQ feedback resource corresponding to the scheduled downlink resource;

determining, by the UE, the time interval configuration used by the HARQ feedback resource corresponding to the scheduled downlink resource based on a resource index of searching the correct PDCCH and a preset rule.

Preferably, the resource index of the foregoing PDCCH includes at least one of: a PDCCH index, a CCE index, an index of search space, and an index of control resource set.

Preferably, the preset rule includes determining the time interval configuration used by the HARQ feedback resource corresponding to the scheduled downlink resource based on an index of search the correct PDCCH, a reference time interval preset by a system, and a preset time interval step size

In order to achieve the above object, the present application further provides a user equipment (UE), the UE include a downlink control channel receiving and detecting unit, a configuration determining unit, and a transmission unit;

wherein the downlink control channel receiving and detecting unit is configured to detect a downlink control channel using a compact DCI format;

the configuration determining unit is configured to acquire configuration information in a preconfigured manner when the user equipment correctly detected the downlink control channel using the compact DCI format;

the transmission unit is configured to perform an uplink transmission based on the configuration information.

In order to achieve the above object, the present application further provides a user equipment (UE), the UE includes:

a processor; and

a memory configured to store machine readable instructions that, when executed by the processor, cause the processor to perform the foregoing method for transmitting a signal.

Additional aspects and advantages of the present application will partly be presented in the following description, and become apparent in the following description or be appreciated in practicing of the present application.

According to an embodiment of this disclosure, it is possible to overcome a deficiency of the prior art by providing a method and a device for transmitting a signal scheduling an uplink or downlink transmission using a compact downlink control signaling.

### BRIEF DESCRIPTION OF THE DRAWINGS

The above and/or additional aspects and advantages of the present application will become apparent and readily understood by describing in detail embodiments thereof with reference to the accompanying drawings, in which:

FIG. 1 is a schematic diagram of a method for transmitting signals provided by the present application;

FIG. 2 is a schematic diagram of a conventional contention-based random access procedure;

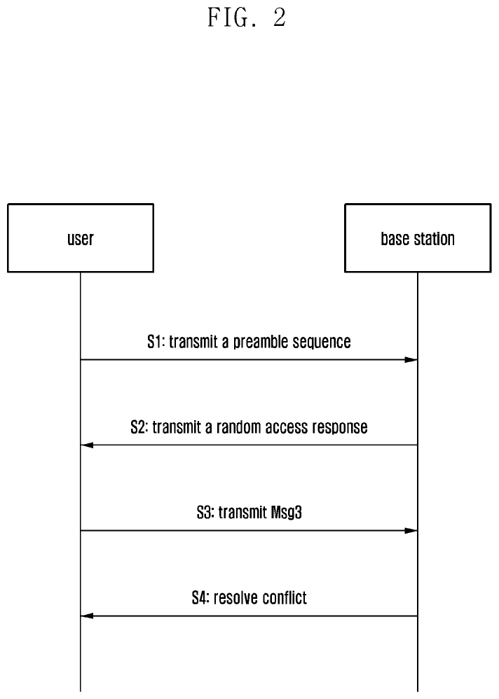

FIG. 3 is a diagram showing an example of determining a PUCCH resource configuration according to a PDCCH;

FIG. 4 is a diagram showing one example of a user equipment used for transmitting signals of the present application;

FIG. 5 is a diagram showing another example of a user equipment used for transmitting signals of the present application.

### DETAILED DESCRIPTION

The embodiments of the present application will be described in detail hereinafter, and examples of the embodiments are illustrated in the accompanying drawings, throughout which same or similar reference numerals refer to same or similar elements or elements having same or similar functions. The embodiments described hereinafter with reference to the drawings are illustrative, merely used for explaining the present application and should not be regarded as any limitations thereto.

It should be understood by those skill in the art that singular forms “a”, “an”, “the”, and “said” may be intended to include plural forms as well, unless otherwise stated. It should be further understood that terms “include/comprise” used in this specification specify the presence of the stated features, integers, steps, operations, elements and/or components, but not exclusive of the presence or addition of one or more other features, integers, steps, operations, elements, components, and/or combinations thereof. It should be understood that when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

Those skilled in the art will appreciate that all terms (including technical terms and scientific terms) used herein have the same meaning as commonly understood by one of ordinary skill in the art to belonging to the field of the present application, unless otherwise defined. It should also be understood that those terms, such as those defined in a general dictionary, should be considered to have a meaning consistent with the meaning in the context of the prior art, and, unless clearly defined herein, should not be understood differently or as having an excessively formal meaning.

Those skilled in the art may understand that the “terminal” and “terminal device” as used herein include both a wireless signal receiver device only having a wireless signal receiver without a transmitting capability, and a receiving and transmitting hardware having a device capable of receiving and transmitting hardware for two-way communication over a two-way communication link. Such device may include: a cellular or other communication device having a single line display or a multi-line display, or a cellular or other communication device without a multi-line display; a personal communications service (PCS), which may combine voice, data processing, fax and/or data communication capabilities; a PDA (Personal Digital Assistant), which may include a radio frequency receiver, a pager, Internet/Intranet access, a web browser, a notepad, a calendar, and/or a GPS (Global Positioning System) receiver; a conventional laptop and/or a palmtop computer or other devices having a conventional laptop and/or palmtop computer or other devices and/or having a radio frequency receiver. As used herein, “terminal” and “terminal device” may be portable, transportable, installed in a vehicle (in aviation, sea and/or land), or adapted and/or configured to operate locally, and/or operated in any other location on the earth and/or space in a distributed form. As used herein, “terminal” and “terminal device” may also be a communication terminal, an internet terminal, and a music/video playing terminal, for example, a PDA, a MID (Mobile Internet Device), and/or a mobile phone having a music/video playback function, and may also be a smart TV, a set-top box and other devices.

To make the objects, technical solutions and advantages of the present application obvious, the present application will be further described below in detail with reference to the accompanying drawings.

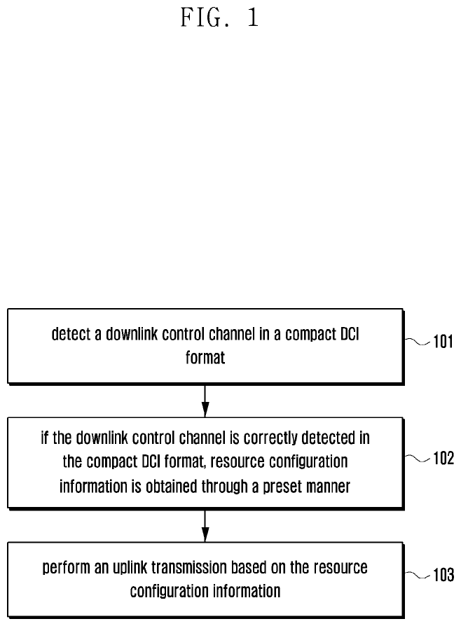

An example of the method for transmitting a signal provided by the present application is illustrated in FIG. 1, wherein the UE detects a downlink control channel using a compact DCI format; when the UE has correctly detected the downlink control channel using the compact DCI format, the UE acquires a configuration information by using a preconfigured manner; the UE performs an uplink transmission based on the configuration information.

Before the establishment of the radio resource control (RRC) link, the UE does not obtain a specific system configuration information, so it does not require a complex control signaling to schedule an uplink transmission or a downlink transmission, that is, it may use an extremely compact downlink control signaling to send scheduling information, as illustrated in the following table.

Table 1. an example table of the compact downlink control signaling

| Parameter | The number of bits | |
|---|---|---|
| domains | required | Description |
| Head | X | Indicating an uplink or a downlink scheduling, for |
| | | example, X = 1, “0” indicates an uplink scheduling; |
| | | “1” indicates a downlink scheduling. |
| Frequency | Y | Using a fixed resource configuration type, such as |
| domain resource | | a resource configuration type 1; the specific |
| configuration | | number of occupied bits Y is determined by the |
| | | size of the frequency band portion in which the |
| | | configured resource is located. |
| Time domain | Z | Indicating the location of the configured resource |
| resource | | in the time domain. |
| configuration | | |
| Modulation code | M | Using a limited number of optional modulation |
| combination | | code parameters. |

Therefore, the size of the compact DCI (i.e., the number of bits required) may be smaller than the size of the DCI used by a normal scheduling, when the UE finds that the received PDCCH is successfully detected using the compact DCI format, it needs to determine some configuration information for receiving and/or transmitting subsequent data.

When the uplink transmission is scheduled by using the compact downlink control signaling, for example, when the random access message 3 is retransmitted, (if the CRC of the DCI is scrambled using the TC-RNTI), the UE needs to set one or more of the following parameters to perform the uplink transmission based on a specified configuration:

a redundancy version (RV);

a frequency hopping flag (FH flag);

a transmit power control command (TPC command).

Wherein, the configuration of one or more of the above parameters may be determined based on a preset configuration or a preset rule to perform the uplink transmission.

When the downlink transmission is scheduled by using a compact downlink control signaling, for example, when the random access conflict resolution, i.e. message 4, is scheduled, (if the CRC of the DCI is scrambled using the TC-RNTI), the UE needs to set one or more of the following parameters based on a specified configuration to receive downlink data and send subsequent acknowledgement feedback (ACK feedback):

Transmit power control command (TPC command);

an ACK resource indication (ARI);

a hybrid auto retransmission request timing (HARQ timing).

Wherein, the configuration of one or more of the above parameters may be determined based on a preset configuration or a preset rule to perform the uplink transmission.

In order to facilitate the understanding of the present application, the above technical solutions of the present application are further described below in the interaction mode of devices in combination with specific application situations as follows.

### Embodiment 1

In this embodiment, before the establishment of the radio resource control (RRC) link, the UE does not obtain specific system configuration information, so it does not require a complex control signaling to schedule uplink transmission, such as scheduling of retransmission of random access message 3, that is, it may use a compact downlink control signaling to transmit scheduling information, as illustrated in the following table.

Table 2. an example table of the compact downlink control signaling for uplink scheduling

| Parameter | The number of bits | |
|---|---|---|
| domains | required | Description |
| Head | X = 1 | Indicating and uplink or a downlink scheduling, |
| | | for example, X = 1, “0” indicates an uplink |
| | | scheduling; “1” indicates a downlink scheduling. |
| | | In this embodiment, the value of the parameter |
| | | domain is “0”. |
| Frequency | Y = 5 | Using a fixed resource configuration type, such as |
| domain resource | | resource configuration type 1; the specific number |
| configuration | | of occupied bits Y is determined by the size of the |
| | | frequency band portion in which the configured |
| | | resource is located. |
| Time domain | Z = 2 | Indicating the location of the configured resource |
| resource | | in the time domain. |
| configuration | | |
| Modulation code | M = 4 | Using a limited number of optional modulation |
| combination | | code parameters. |

Each of the above number of bits required is an example and may be set to other values according to actual requirements. Moreover, the size of the compact DCI (i.e., the number of bits required) may be smaller than the size of the DCI used by a normal scheduling, so when the UE finds that the received PDCCH is successfully detected using the compact DCI format, it needs to determine some configuration information for receiving and/or transmitting the subsequent data.

When the retransmission of the random access message 3 is scheduled by using a compact downlink control signaling, (if the CRC of the DCI is scrambled using the TC-RNTI), the UE needs to set one or more of the following parameters to perform the uplink transmission based on the specified configuration.

Redundancy version (RV)

1. Using the same redundancy version as the redundancy version configured by an uplink license carried in the random access response; or

2. Using a preset redundancy version number, such as RV0, or RV3, etc.; or

3. Determining the redundancy version used in a certain order; if the predefined order is 0312, the first transmission of the message 3 uses redundancy version 0, and then the retransmission of the message 3 scheduled by the downlink control signaling uses the redundancy version determined in order; for example, the retransmission of the message 3 that receives the downlink control signaling scheduling at the first time uses redundancy version 3, and the retransmission of the message 3 that receives the downlink control signaling scheduling at the second time uses redundancy version 1, and so on, when the number of retransmissions is greater than the number of redundancy versions, the redundancy version may be determined cyclically, that is, after redundancy version 2 is used, redundancy version 0 is used when message 3 is transmitted at the next time.

Frequency Hopping Flag (FH Flag)

1. Using the same flag as the frequency hopping flag configured by an uplink license carried in the random access response, for example, if the frequency hopping flag configured by the uplink license carried in the random access response is enabled, the subsequent retransmission of the message 3 also enables the frequency hopping; or

2. According to a preset frequency hopping flag, such as, the retransmission of the message 3 corresponding to the DCI scheduling is preset to enable the frequency hopping, or the retransmission of the message 3 corresponding to the DCI scheduling is preset to disenable the frequency hopping; or

3. Determining the frequency hopping flag based on a preset rule; if the preset rule is the retransmission of the message 3 that receives the DCI scheduling at the Nth time, the frequency hopping is enabled, wherein the value of N may be 0, 1, a preset value, or a half of the maximum number of transmissions of the preset message 3.

Transmit Power Control Command (TPC Command)

1. Using the same value as the TPC command configured by an uplink license carried in the random access response; or,

2. Using a preset value, for example, the TPC command is set to 0; or

3. Determining the TPC command based on a preset rule, for example, the TPC command is sequentially increased based on the number of retransmissions of the received message 3; for example, when the first message 3 is transmitted, it is TPC command=0, and when the first message 3 is retransmitted, TPC command=TPC command_old+step size=0+2=2; and so on.

### Embodiment 2 (a Compact DCI Scheduling Downlink Msg 4)

In this embodiment, before the establishment of the radio resource control (RRC) link, the UE does not obtain a specific system configuration information, so it does not require a complex control signaling to schedule a downlink transmission, such as the scheduling of random access message 4, and the corresponding configuration of ACK feedback of message 4, that is, it may use an extremely compact downlink control signaling to send scheduling information, as illustrated in the following table.

Table 3, an example table of the extremely compact downlink control signaling for downlink scheduling

| Parameter | The number of bits | |
|---|---|---|
| domains | required | Description |
| Head | X = 1 | Indicating an uplink or a downlink scheduling, for |
| | | example, X = 1, “0” indicates an uplink scheduling; |
| | | “1” indicates a downlink scheduling. In this |
| | | embodiment, the value of the parameter domain is |
| | | “1”. |
| Frequency | Y = 5 | Using a fixed resource configuration type, such as |
| domain resource | | resource configuration type 1; the specific number |
| configuration | | of occupied bits Y is determined by the size of the |
| | | frequency band portion in which the configured |
| | | resource is located. |
| Time domain | Z = 2 | Indicating the location of the configured resource |
| resource | | in the time domain. |
| configuration | | |
| Modulation code | M = 4 | Using a limited number of optional modulation |
| combination | | code parameters. |

Each of the above number of bits required is an example and may be set to other values according to actual requirements. Moreover, the size of a compact DCI (i.e., the number of bits required) may be smaller than the size of a DCI used by a normal scheduling, so when the UE finds that the received PDCCH is successfully detected using a compact DCI format, it needs to determine some configuration information for receiving and/or transmitting subsequent data.

When the compact downlink control signaling is used to schedule the random access message 4 and the corresponding configuration of the ACK feedback of the message 4, (if the CRC of the DCI is scrambled using the TC-RNTI or C-RNTI), the UE needs to set one or more of the following parameters to perform the uplink transmission based on a specified configuration:

Transmit Power Control Command (TPC Command)

1. Using the same value as the TPC command configured by un uplink license carried in the random access response; or

2. Using the configuration of the TPC command in the scheduling information which scheduled the last transmitted message 3; or

3. Using a preset value, for example, the TPC command is set to 0; or

4. Determining the TPC command based on a preset rule, for example, the TPC command is sequentially increased according to the number of retransmissions of the received message 3; for example, when the first message 3 is transmitted, it is TPC command=0, and when the first message 3 is retransmitted, TPC command=TPC command_old+step size=0+2=2; and so on.

ACK resource indication (ARI), for example, a PUCCH resource indication used to send ACK feedback.

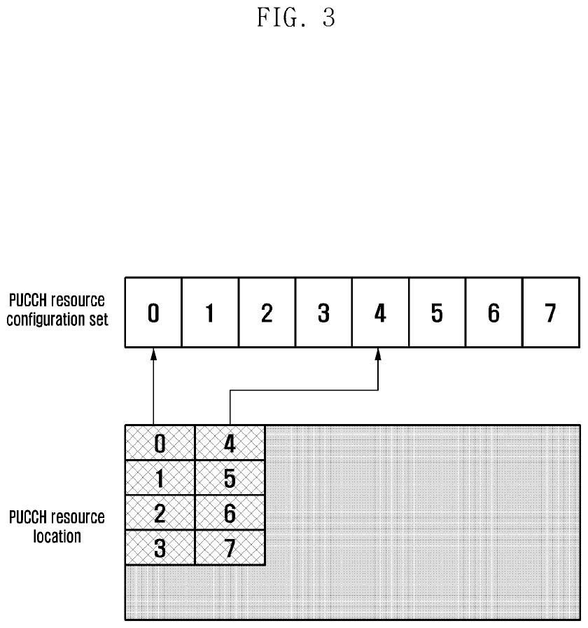

1. Determining, based on a resource index of searching the correct PDCCH (which may also be a CCE index, an index of a search space, and an index of a control resource set), the used PUCCH resource configuration used from a PUCCH resource configuration set configured or pre-configured in the system information; as illustrated in FIG. 3, for example, when the UE determines that the 0th PDCCH in the search space is its own matching PDCCH (such as, the CRC of the PDCCH is correctly descrambled using the TC-RNTI), the corresponding UE uses the 0th PUCCH resource configuration in the PUCCH resource set configured in the system information; or

2. Determining based on a pre-configured PUCCH resource configuration that for example, the system is pre-configured to use the ACK feedback resource in the random access conflict resolution message scheduled by the compact DCI; and as long as the random access conflict resolution message is obtained by the UE using the scheduling of the compact DCI, the ACK feedback resource pre-configured by the system is always used.

Hybrid Auto Retransmission Request Timing (HARQ Timing)

1. Determining a hybrid auto retransmission request timing based on a preset time interval, that is, after K time units (such as K time slots, but it may also be other time units, such as a OFDM symbol index, a symbol group index, and a subframe index) are preset, and then the ACK feedback is prepared to be sent, for example, if the time at which the correct PDCCH or PDSCH is received is the time slot N, the ACK feedback is sent on the corresponding time slot of N+K; or

2. Determining a hybrid auto retransmission request timing based on an index of searching the correct PDCCH (which may also be a CCE index, an index of a search space, an index of a control resource set) and a preset rule; if a reference time interval is preset to K time units, based on the index of searching the correct PDCCH, such as the fourth PDCCH, the hybrid auto retransmission request timing of the UE is K+4*T_step, wherein T_step is a preset time unit step size, if the time at which the correct PDCCH or PDSCH is received is time slot N, the ACK feedback is sent on the corresponding time slot at N+K+4*T_step.

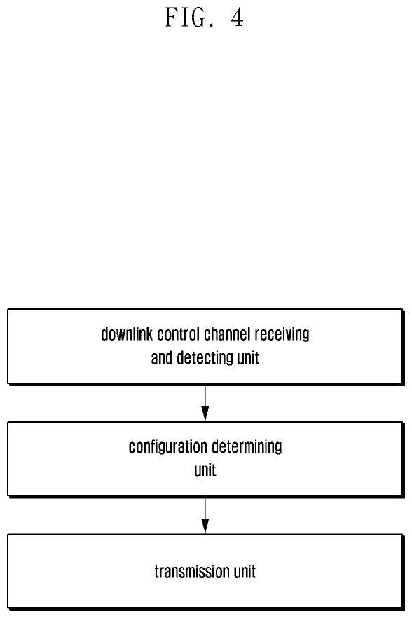

This embodiment provides a user equipment (UE) for transmitting a signal according to the present application, as illustrated in FIG. 4, the UE includes: a downlink control channel receiving and detecting unit, a configuration determining unit, and a transmission unit; wherein:

the downlink control channel receiving and detecting unit is configured to detect a downlink control channel using a compact DCI format;

the configuration determining unit is configured to acquire configuration information in a preconfigured manner when the user equipment correctly detected the downlink control channel using the compact DCI format;

the transmission unit is configured to perform an uplink transmission based on the configuration information.

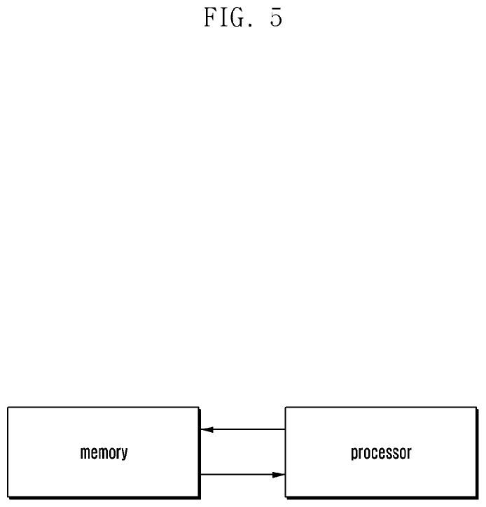

This embodiment further provides a user equipment for transmitting a signal according to the present application, as illustrated in FIG. 5, the user equipment includes:

a processor; and

a memory configured to store machine readable instructions that, when executed by the processor, cause the processor to perform the foregoing method for transmitting a signal.

The foregoing description are merely illustrating of the preferred embodiments of the present application and is not intended to limit the present application, and that any modifications, equivalents, improvements, etc., which fall into the spirit and principles of this application, are intended to be included within the scope of the present application.

It should be understood by those skilled in the art that the present application involves devices for carrying out one or more of operations as described in the present application. Those devices may be specially designed and manufactured as intended, or may comprise well known devices in a general-purpose computer. Those devices have computer programs stored therein, which are selectively activated or reconstructed. Such computer programs may be stored in a device (e.g. a computer) readable medium or in any type of medium suitable for storing electronic instructions and respectively coupled to a bus, and the computer readable medium includes but are not limited to any type of disks (including floppy disks, hard disks, optical disks, CD-ROM and magneto optical disks), an ROM (Read-Only Memory), an RAM (Random Access Memory), an EPROM (Erasable Programmable Read-Only Memory), an EEPROM (Electrically Erasable Programmable Read-Only Memory), a flash memory, a magnetic card or an optical line card. In other words, the readable medium comprises any medium storing or transmitting information in a device (e.g., a computer) readable form.

It should be understood by those skilled in the art that computer program instructions may be used to realize each block in structure diagrams and/or block diagrams and/or flowcharts as well as a combination of blocks in the structure diagrams and/or block diagrams and/or flowcharts. It should be understood by those skilled in the art that these computer program instructions can be provided to general purpose computers, special purpose computers or other processors of programmable data processing means to be implemented, so that solutions designated in a block or blocks of the structure diagrams and/or block diagrams and/or flow diagrams are executed by computers or other processors of programmable data processing means.

It may be understood by those skilled in the art that the steps, measures and solutions in the operations, methods and flows already discussed in the present application may be alternated, changed, combined or deleted. Further, other steps, measures and solutions in the operations, methods and flows already discussed in the present application may also be alternated, changed, rearranged, decomposed, combined or deleted. Further, the steps, measures and solutions in the art in the operations, methods and operations disclosed in the present application may also be alternated, changed, rearranged, decomposed, combined or deleted.

The foregoing descriptions are merely some implementations of the present application. It should be noted that, to those skilled in the art, various improvements and modifications may be made without departing from the principle of the present application, and these improvements and modifications shall be regarded as falling into the protection scope of the present application.

1. A method for transmitting a signal by a user equipment (UE), the method comprising:
detecting a downlink control channel using a compact downlink control information (DCI) format;
acquiring configuration information in a preconfigured manner when the UE correctly detected the downlink control channel using the compact DCI format; and
performing an uplink transmission based on the configuration information.

2. The method of claim 1, wherein the configuration information comprises at least one of:
a redundancy version configuration used by a scheduled uplink resource;
a transmission power control configuration used by the scheduled uplink resource;
a frequency hopping flag configuration used by the scheduled uplink resource;
a transmission power control configuration used by a hybrid automatic repeat request (HARQ) feedback resource corresponding to a scheduled downlink resource;
a resource indication configuration used by the HARQ feedback resource corresponding to the scheduled downlink resource; or
a time interval configuration used by the HARQ feedback resource corresponding to the scheduled downlink resource.

3. The method of claim 2, wherein when the configuration information comprises the redundancy version configuration used by the scheduled uplink resource, the acquiring the configuration information in the preconfigured manner comprises at least one of:
using a same redundancy version as the redundancy version configured by an uplink license carried in a random access response as the redundancy version configuration used by the scheduled uplink resource;
using a preset redundancy version as the redundancy version configuration used by the scheduled uplink resource; or
determining the redundancy version configuration used by the scheduled uplink resource in an order of an uplink transmission and an order of the preset redundancy version.

4. The method of claim 2, wherein when the configuration information comprises the transmission power control configuration used by the scheduled uplink resource, the acquiring the configuration information in the preconfigured manner comprises at least one of:
using a same configuration as the transmission power control configured by an uplink license carried in a random access response as the transmission power control configuration used by the scheduled uplink resource;
using a preset value of the transmission power control as the transmission power control configuration used by the scheduled uplink resource; or
determining the transmission power control configuration used by the scheduled uplink resource based on the number of retransmissions sent by the uplink and a transmission power control step size preset by a system.

5. The method of claim 2, wherein when the configuration information comprises the frequency hopping flag configuration used by the scheduled uplink resource, the acquiring the configuration information by the UE in the preconfigured manner comprises at least one of:
using a same configuration as the frequency hopping flag configured by an uplink license carried in a random access response as the frequency hopping flag configuration used by the scheduled uplink resource;
using a preset frequency hopping flag configuration as the frequency hopping flag configuration used by the scheduled uplink resource; or
determining the frequency hopping flag configuration used by the scheduled uplink resource based on a preset rule, wherein the preset rule comprises: if the number of the scheduled uplink transmission exceeds a preset number of retransmissions, the UE determines that the frequency hopping flag configuration used by the scheduled uplink resource is enabling the frequency hopping, otherwise the UE determines that the frequency hopping flag configuration used by the scheduled uplink resource is disenabling the frequency hopping.

6. The method of claim 2, wherein when the configuration information comprises the transmission power control configuration used by the HARQ feedback resource corresponding to the scheduled downlink resource, the acquiring the configuration information by the UE in a preconfigured manner comprises at least one of:
using the same configuration as the transmission power control configured by an uplink license carried in a random access response as the transmission power control configuration used by the HARQ feedback resource corresponding to the scheduled downlink resource;
using the same configuration as the transmission power control configured in the latest scheduled uplink transmission as the transmission power control configuration used by the HARQ feedback resource corresponding to the scheduled downlink resource;
using a preset value of the transmission power control as the transmission power control configuration used by the HARQ feedback resource corresponding to the scheduled downlink resource; or
determining based on the number of retransmissions sent by the uplink and a transmission power control step size preset by a system, the transmission power control configuration used by the HARQ feedback resource corresponding to the scheduled downlink resource.

7. The method of claim 2, wherein when the configuration information comprises the resource indication configuration used by the HARQ feedback resource corresponding to the scheduled downlink resource, the acquiring the configuration information by the UE in a preconfigured manner comprises at least one of:
determining based on a resource index of receiving a correct physical downlink control channel (PDCCH), a physical uplink control channel (PUCCH) resource configuration used by the HARQ feedback resource corresponding to the scheduled downlink resource from a PUCCH resource configuration set configured or pre-configured in the system information; or
determining the PUCCH resource configuration used by the HARQ feedback resource corresponding to the scheduled downlink resource based on the pre-configured PUCCH resource configuration.

8. The method of claim 2, wherein when the configuration information comprises the time interval configuration used by the HARQ feedback resource corresponding to the scheduled downlink resource, the acquiring the configuration information by the UE in a preconfigured manner comprises at least one of:
using a preset time interval as the time interval configuration used by the HARQ feedback resource corresponding to the scheduled downlink resource; or
determining the time interval configuration used by the HARQ feedback resource corresponding to the scheduled downlink resource based on a resource index of searching a correct physical downlink control channel (PDCCH) and a preset rule.

9. The method of claim 7, wherein the resource index comprises at least one of: a PDCCH index, a control channel element (CCE) index, an index of search space, or an index of control resource set.

10. The method of claim 8, wherein the preset rule comprises determining the time interval configuration used by the HARQ feedback resource corresponding to the scheduled downlink resource based on an index of search the correct PDCCH, a reference time interval preset by a system, and a preset time interval step size.

11. A user equipment (UE), the UE comprising:
a downlink control channel receiving and detecting unit,
a configuration determining unit, and
a transmission unit;
wherein the downlink control channel receiving and detecting unit is configured to detect a downlink control channel using a compact downlink control information (DCI) format;
the configuration determining unit is configured to acquire configuration information in a preconfigured manner when the user equipment correctly detected the downlink control channel using the compact DCI format; and
the transmission unit is configured to perform an uplink transmission based on the configuration information.

12. A user equipment (UE), the UE comprising:
a processor; and
a memory configured to store machine readable instructions that, when executed by the processor, cause the processor to:
detect a downlink control channel using a compact downlink control information (DCI) format;
acquire configuration information in a preconfigured manner when correctly detecting the downlink control channel using the compact DCI format; and
perform an uplink transmission based on the configuration information.

13. The method of claim 8, wherein the resource index comprises at least one of: a PDCCH index, a control channel element (CCE) index, an index of search space, or an index of control resource set.

14. The UE of claim 12, wherein the configuration information comprises at least one of:
a redundancy version configuration used by a scheduled uplink resource;
a transmission power control configuration used by the scheduled uplink resource;
a frequency hopping flag configuration used by the scheduled uplink resource;
a transmission power control configuration used by a hybrid automatic repeat request (HARQ) feedback resource corresponding to a scheduled downlink resource;
a resource indication configuration used by the HARQ feedback resource corresponding to the scheduled downlink resource; or
a time interval configuration used by the HARQ feedback resource corresponding to the scheduled downlink resource.

15. The UE of claim 14, wherein when the configuration information comprises the redundancy version configuration used by the scheduled uplink resource, the instructions, when executed by the processor, cause the processor to acquire the configuration information in the preconfigured manner in accordance with at least one of:
using a same redundancy version as the redundancy version configured by an uplink license carried in a random access response as the redundancy version configuration used by the scheduled uplink resource;
using a preset redundancy version as the redundancy version configuration used by the scheduled uplink resource; or
determining the redundancy version configuration used by the scheduled uplink resource in an order of an uplink transmission and an order of the preset redundancy version.

16. The UE of claim 14, wherein when the configuration information comprises the transmission power control configuration used by the scheduled uplink resource, the instructions, when executed by the processor, cause the processor to acquire the configuration information in the preconfigured manner in accordance with at least one of:
using a same configuration as the transmission power control configured by an uplink license carried in a random access response as the transmission power control configuration used by the scheduled uplink resource;
using a preset value of the transmission power control as the transmission power control configuration used by the scheduled uplink resource; or
determining the transmission power control configuration used by the scheduled uplink resource based on the number of retransmissions sent by the uplink and a transmission power control step size preset by a system.

17. The UE of claim 14, wherein when the configuration information comprises the frequency hopping flag configuration used by the scheduled uplink resource, the instructions, when executed by the processor, cause the processor to acquire the configuration information in the preconfigured manner in accordance with at least one of:
using a same configuration as the frequency hopping flag configured by an uplink license carried in a random access response as the frequency hopping flag configuration used by the scheduled uplink resource;
using a preset frequency hopping flag configuration as the frequency hopping flag configuration used by the scheduled uplink resource; or
determining the frequency hopping flag configuration used by the scheduled uplink resource based on a preset rule, wherein the preset rule comprises: if the number of the scheduled uplink transmission exceeds a preset number of retransmissions, the processor determines that the frequency hopping flag configuration used by the scheduled uplink resource is enabling the frequency hopping, otherwise the processor determines that the frequency hopping flag configuration used by the scheduled uplink resource is disenabling the frequency hopping.

18. The UE of claim 14, wherein when the configuration information comprises the transmission power control configuration used by the HARQ feedback resource corresponding to the scheduled downlink resource, the instructions, when executed by the processor, cause the processor to acquire the configuration information in a preconfigured manner in accordance with at least one of:
using a same configuration as the transmission power control configured by an uplink license carried in a random access response as the transmission power control configuration used by the HARQ feedback resource corresponding to the scheduled downlink resource;
using the same configuration as the transmission power control configured in the latest scheduled uplink transmission as the transmission power control configuration used by the HARQ feedback resource corresponding to the scheduled downlink resource;
using a preset value of the transmission power control as the transmission power control configuration used by the HARQ feedback resource corresponding to the scheduled downlink resource; or
determining based on the number of retransmissions sent by the uplink and a transmission power control step size preset by a system, the transmission power control configuration used by the HARQ feedback resource corresponding to the scheduled downlink resource.

19. The UE of claim 14, wherein when the configuration information comprises the resource indication configuration used by the HARQ feedback resource corresponding to the scheduled downlink resource, the instructions, when executed by the processor, cause the processor to acquire the configuration information in a preconfigured manner in accordance with at least one of:
determining, based on a resource index of receiving a correct physical downlink control channel (PDCCH), a physical uplink control channel (PUCCH) resource configuration used by the HARQ feedback resource corresponding to the scheduled downlink resource from a PUCCH resource configuration set configured or pre-configured in the system information; or
determining the PUCCH resource configuration used by the HARQ feedback resource corresponding to the scheduled downlink resource based on the pre-configured PUCCH resource configuration.

20. The UE of claim 14, wherein when the configuration information comprises the time interval configuration used by the HARQ feedback resource corresponding to the scheduled downlink resource, the instructions, when executed by the processor, cause the processor to acquire the configuration information in a preconfigured manner in accordance with at least one of:
using a preset time interval as the time interval configuration used by the HARQ feedback resource corresponding to the scheduled downlink resource; or
determining the time interval configuration used by the HARQ feedback resource corresponding to the scheduled downlink resource based on a resource index of searching a correct physical downlink control channel (PDCCH) and a preset rule.
